(19) United States
(12) Patent Application Publication
(10) Pub. No.: US 2026/0120318 A1
(43) Pub. Date: Apr. 30, 2026

(54) INFORMATION PROCESSING APPARATUS, INFORMATION PROCESSING METHOD, AND COMPUTER-READABLE RECORDING MEDIUM

(71) Applicant: NEC Corporation, Tokyo (JP)

(72) Inventors: Jiro ABE, Tokyo (JP); Tsukasa MATSUO, Tokyo (JP)

(73) Assignee: NEC Corporation, Tokyo (JP)

(21) Appl. No.: 19/354,881

(22) Filed: Oct. 10, 2025

(30) Foreign Application Priority Data
Oct. 30, 2024 (JP) 2024-190795

(51) Int. Cl. G06T 7/73; G06T 7/00

(52) U.S. Cl. CPC G06T 7/74; G06T 7/001

(57) ABSTRACT

An information processing apparatus includes a data acquisition unit that obtains first moving image data from a first specific portion to a second specific portion and second moving image data from the second specific portion to an inspection point, a camera posture calculation unit that calculates a posture at the first specific portion (first three-dimensional camera posture) in three-dimensional data, calculates the posture at the second specific portion (second three-dimensional camera posture) in the three-dimensional data from the first three-dimensional camera posture and the posture in a frame of the second specific portion, and calculates the posture at the inspection point (third three-dimensional camera posture) in the three-dimensional data from the second three-dimensional camera posture and the posture in a frame of the inspection point, and a position identification unit that identifies a position of the inspection point in the three-dimensional data using the third three-dimensional camera posture.

This application is based upon and claims the benefit of priority from Japanese patent application No. 2024-190795, filed on October 30, 2024, the disclosure of which is incorporated herein in its entirety by reference.

### TECHNICAL FIELD

The present disclosure relates to a technique for comparing three-dimensional point cloud data of an object with a captured image of the object.

### BACKGROUND ART

In recent years, there has been a demand for efficient management of infrastructures such as bridges. For this reason, as image processing techniques have been improved in recent years, a technique for managing a deteriorated portion of an infrastructure using three-dimensional point cloud data has been proposed (e.g., see JP 2020-154466 A).

Specifically, JP 2020-154466 A discloses an apparatus capable of displaying three-dimensional point cloud data of an infrastructure on a screen and pasting an image captured at a time of inspection on a relevant portion of the three-dimensional point cloud data on the screen. According to the apparatus disclosed in JP 2020-154466 A, a manager may easily grasp the deteriorated portion and the like of the infrastructure, and may efficiently manage the infrastructure.

### SUMMARY

Meanwhile, in order to efficiently manage the apparatus disclosed in JP 2020-154466 A, it is necessary to accurately align an imaging target portion of the image captured at the time of inspection with the relevant portion of the three-dimensional point cloud data. However, in a case of an infrastructure having a cavity inside thereof, such as a box girder bridge, a missing portion may be located at a position that does not appear in the three-dimensional point cloud data. In such a case, it is difficult for the apparatus disclosed in JP 2020-154466 A to display the missing portion on the three-dimensional point cloud data.

An example of an object of the present disclosure is to enable alignment with a relevant portion of three-dimensional point cloud data even for an imaging portion that does not appear in three-dimensional data of an object.

In order to achieve the object described above, an information processing apparatus according to an aspect of the present disclosure includes a data acquisition unit that obtains first moving image data, which is generated by capturing a moving image of an object from a first specific portion to a second specific portion and retains a camera posture at a time of capturing the moving image for each frame, and second moving image data, which is generated by capturing the object from the second specific portion to an inspection point and retains the camera posture at the time of capturing the moving image for each frame, a camera posture calculation unit that compares a frame including the first specific portion in the first moving image data with three-dimensional data of the object, and calculates, as a first three-dimensional camera posture, the camera posture at a portion relevant to the first specific portion in the three-dimensional data, calculates, as a second three-dimensional camera posture, the camera posture at a portion relevant to the second specific portion in the three-dimensional data using the first three-dimensional camera posture and the camera posture retained in a frame including the second specific portion, and calculates, as a third three-dimensional camera posture, the camera posture at a portion relevant to the inspection point in the three-dimensional data using the second three-dimensional camera posture and the camera posture retained in a frame including the inspection point in the second moving image data, and a position identification unit that identifies a position of the portion relevant to the inspection point in the three-dimensional data using the third three-dimensional camera posture.

In order to achieve the object described above, an information processing method according to an aspect of the present disclosure includes a data acquisition step of obtaining first moving image data, which is generated by capturing a moving image of an object from a first specific portion to a second specific portion and retains a camera posture at a time of capturing the moving image for each frame, and second moving image data, which is generated by capturing the object from the second specific portion to an inspection point and retains the camera posture at the time of capturing the moving image for each frame, a camera posture calculation step including comparing a frame including the first specific portion in the first moving image data with three-dimensional data of the object, and calculating, as a first three-dimensional camera posture, the camera posture at a portion relevant to the first specific portion in the three-dimensional data, calculating, as a second three-dimensional camera posture, the camera posture at a portion relevant to the second specific portion in the three-dimensional data using the first three-dimensional camera posture and the camera posture retained in a frame including the second specific portion, and calculating, as a third three-dimensional camera posture, the camera posture at a portion relevant to the inspection point in the three-dimensional data using the second three-dimensional camera posture and the camera posture retained in a frame including the inspection point in the second moving image data, and a position identification step of identifying a position of the portion relevant to the inspection point in the three-dimensional data using the third three-dimensional camera posture.

Furthermore, in order to achieve the object described above, a computer-readable recording medium according to an aspect of the present disclosure records a program including an instruction for causing a computer to perform a process including a data acquisition step of obtaining first moving image data, which is generated by capturing a moving image of an object from a first specific portion to a second specific portion and retains a camera posture at a time of capturing the moving image for each frame, and second moving image data, which is generated by capturing the object from the second specific portion to an inspection point and retains the camera posture at the time of capturing the moving image for each frame, a camera posture calculation step including comparing a frame including the first specific portion in the first moving image data with three-dimensional data of the object, and calculating, as a first three-dimensional camera posture, the camera posture at a portion relevant to the first specific portion in the three-dimensional data, calculating, as a second three-dimensional camera posture, the camera posture at a portion relevant to the second specific portion in the three-dimensional data using the first three-dimensional camera posture and the camera posture retained in a frame including the second specific portion, and calculating, as a third three-dimensional camera posture, the camera posture at a portion relevant to the inspection point in the three-dimensional data using the second three-dimensional camera posture and the camera posture retained in a frame including the inspection point in the second moving image data, and a position identification step of identifying a position of the portion relevant to the inspection point in the three-dimensional data using the third three-dimensional camera posture.

As described above, according to the present disclosure, alignment with a relevant portion of three-dimensional point cloud data may be performed even in a case of an imaging portion that does not appear in three-dimensional data of an object.

### BRIEF DESCRIPTION OF THE DRAWINGS

FIG. 1 is a configuration diagram illustrating a schematic configuration of an exemplary information processing apparatus;

FIG. 2 is a configuration diagram specifically illustrating a configuration of an exemplary information processing apparatus;

FIG. 3 is a diagram illustrating an exemplary object;

FIG. 4 is a diagram illustrating an exemplary state of capturing moving image data to be used in the information processing apparatus;

FIG. 5 is a diagram for explaining an exemplary process in a camera posture calculation unit;

FIG. 6 is a flowchart illustrating an exemplary operation of the information processing apparatus; and

FIG. 7 is a block diagram illustrating an exemplary computer that achieves the information processing apparatus.

### EXAMPLE EMBODIMENT

### Example Embodiment

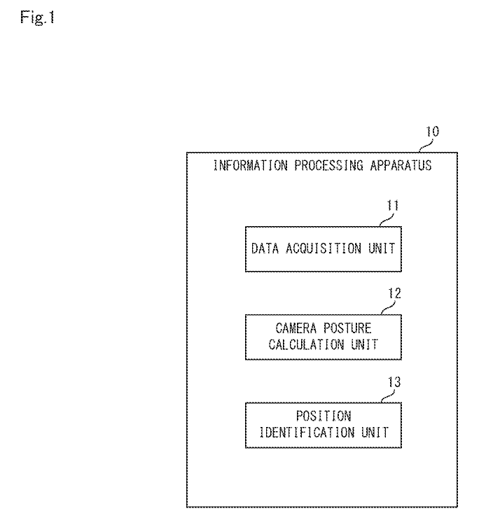

Hereinafter, an information processing apparatus, an information processing method, and a program according to an example embodiment will be described with reference to FIGS. 1 to 7.

### Apparatus Configuration

First, a schematic configuration of an exemplary information processing apparatus will be described with reference to FIG. 1. FIG. 1 is a configuration diagram illustrating a schematic configuration of an exemplary information processing apparatus.

An information processing apparatus 10 illustrated in FIG. 1 is an image collation apparatus that compares three-dimensional point cloud data of an object with a captured image of the object. As illustrated in FIG. 1, the information processing apparatus 10 includes a data acquisition unit 11, a camera posture calculation unit 12, and a position identification unit 13.

The data acquisition unit 11 obtains first moving image data and second moving image data. The first moving image data is generated by moving image capturing from a first specific portion to a second specific portion of the object. The first moving image data retains, for each frame, a camera posture at the time of moving image capturing. The second moving image data is generated by moving image capturing from the second specific portion to an inspection point of the object. In a similar manner to the first moving image data, the second moving image data also retains, for each frame, a camera posture at the time of moving image capturing.

The camera posture calculation unit 12 first compares a frame including the first specific portion in the first moving image data with three-dimensional data of the object to calculate a camera posture at a portion relevant to the first specific portion in the three-dimensional data (which will be referred to as a “first three-dimensional camera posture” hereinafter).

Subsequently, the camera posture calculation unit 12 calculates a camera posture at a portion relevant to the second specific portion in the three-dimensional data (which will be referred to as a “second three-dimensional camera posture” hereinafter) using the first three-dimensional camera posture and the camera posture retained in the frame including the second specific portion in the first moving image data or the second moving image data.

Moreover, the camera posture calculation unit 12 calculates a camera posture at a portion relevant to the inspection point in the three-dimensional data (which will be referred to as a “third three-dimensional camera posture” hereinafter) using the second three-dimensional camera posture and the camera posture retained in the frame including the inspection point in the second moving image data.

The position identification unit 13 identifies the position of the portion relevant to the inspection point in the three-dimensional data using the third three-dimensional camera posture.

In this manner, according to the information processing apparatus 10, the camera posture (third three-dimensional camera posture) of the portion relevant to the inspection point in the three-dimensional data is calculated by using the first moving image data and the second moving image data even if no data relevant to the inspection point is available in the three-dimensional data. Thus, according to the information processing apparatus 10, alignment with the relevant portion of the three-dimensional point cloud data may be performed even in a case of an imaging portion that does not appear in the three-dimensional data of the object.

In the example embodiment, a simple description of “camera posture” indicates a camera posture for each frame of the moving image data. A description of “three-dimensional camera posture” indicates a camera posture in the three-dimensional data.

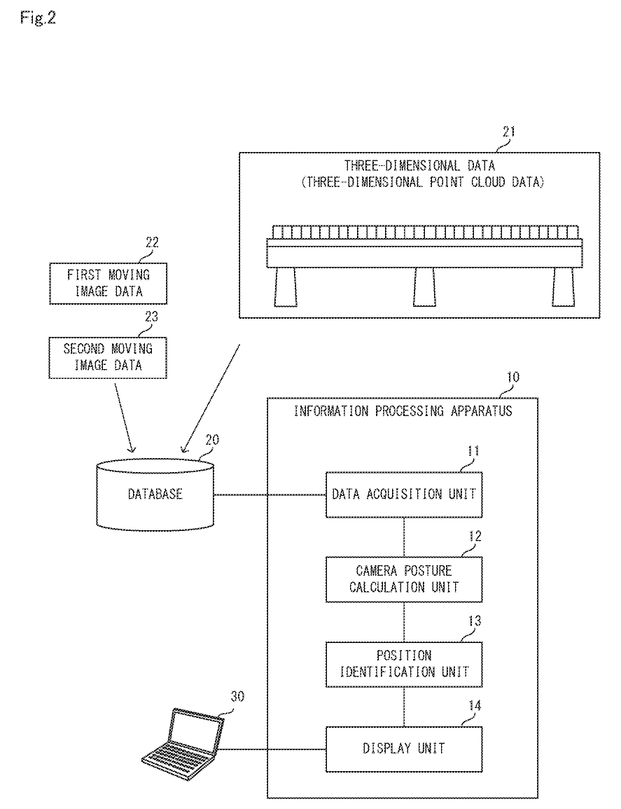

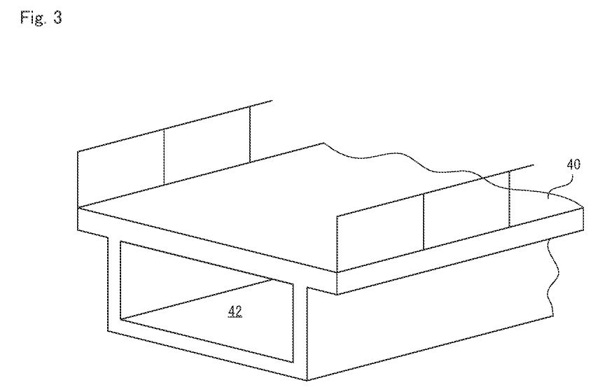

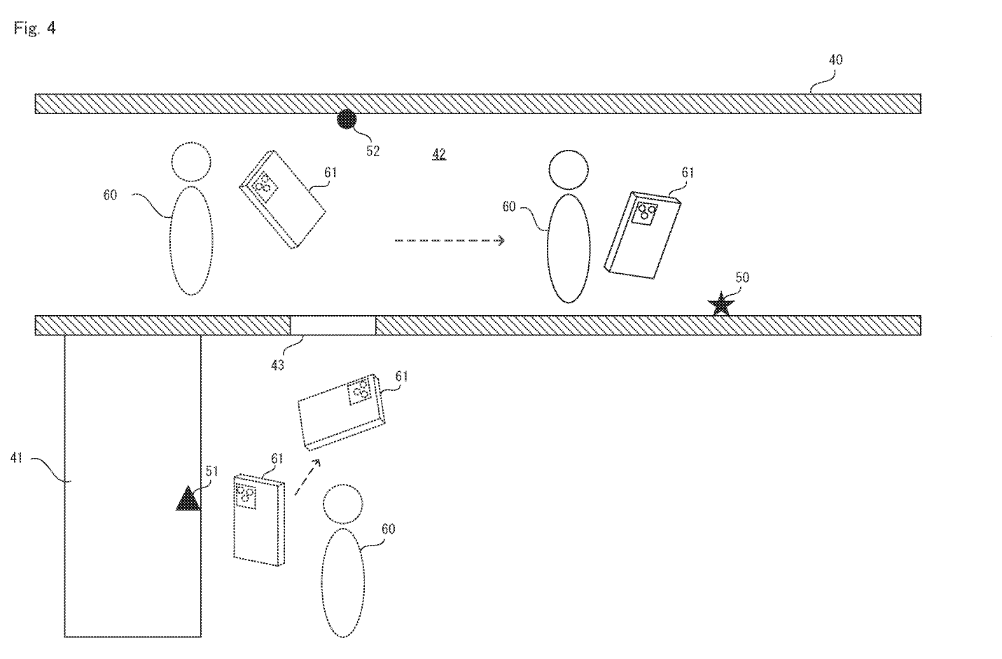

Next, a configuration and a function of an example of the information processing apparatus 10 will be specifically described with reference to FIGS. 2 to 4. FIG. 2 is a configuration diagram specifically illustrating a configuration of an example of the information processing apparatus. FIG. 3 is a diagram illustrating an example of the object. FIG. 4 is a diagram illustrating an exemplary state of capturing moving image data to be used in the information processing apparatus.

As illustrated in FIG. 2, the information processing apparatus 10 includes a display unit 14 in addition to the data acquisition unit 11, the camera posture calculation unit 12, and the position identification unit 13 described above. The information processing apparatus 10 is connected to a database 20 and a terminal device 30 of a user in a data-communicable manner.

The database 20 stores three-dimensional data 21 of the object, first moving image data 22, and second moving image data 23. In the example embodiment, the object is a box girder bridge. The object is not limited to the box girder bridge, and only needs to be a structure having a cavity inside thereof. Other examples of the object include a building, a factory, and a large tank.

For example, three-dimensional point cloud data including a set of feature points of the object is used as the three-dimensional data 21. The three-dimensional point cloud data is generated by, for example, a Structure from Motion (SfM) technique using a large number of two-dimensional images of the object. Moreover, the three-dimensional point cloud data may be generated by a depth sensor (LiDAR, point cloud scanner, etc.).

Here, an example of the object will be described with reference to FIG. 3. As illustrated in FIG. 3, in the example embodiment, the object is a box girder bridge 40. The box girder bridge has an internal space 42. The inspection point (see ★ mark in FIG. 4) exists in the internal space 42. The internal space 42 does not appear in the three-dimensional data 21.

Next, moving image data capturing will be described with reference to FIG. 4. As illustrated also in FIG. 4, an inspection point 50 (marked with ★ in FIG. 4) is located in the internal space 42 of the box girder bridge 40. A first specific portion 51 (marked with ▲ in FIG. 4) is set on a bridge pier 41. The first specific portion 51 only needs to be a portion not missing in the three-dimensional point cloud data. Specific marking may be added in advance to a position relevant to the first specific portion of the box girder bridge 40.

A second specific portion 52 (marked with ● in FIG. 4) is also set in the internal space 42. The second specific portion 52 is set near an entrance 43 of the internal space 42 of the box girder bridge 40 in such a way that an image capturer 60 may perform imaging without entering the internal space 42. Specific marking may be added in advance also to a position relevant to the second specific portion 52 of the box girder bridge 40.

Thus, as illustrated in FIG. 4, the image capturer 60 captures, using an imaging device 61, a moving image from the first specific portion 51 of the bridge pier 41 to the second specific portion 52 of the internal space 42 via the entrance 43. As a result, the first moving image data is created. Next, the image capturer 60 enters the internal space 42 from the entrance 43, and captures, using the imaging device 61, a moving image from the second specific portion 52 to the inspection point 50 while moving in the internal space 42. As a result, the second moving image data is created. In the example of FIG. 4, a smartphone provided with a camera is used as the imaging device 61.

The smartphone serving as the imaging device 61 includes various sensors such as an inertial measurement unit (IMU). At the time of moving image capturing, the smartphone calculates a camera posture using sensor data output from the IMU for each frame. The camera posture may be calculated as visual-inertial odometry (VIO) obtained by combining an image analysis result for each frame with the sensor data output from the IMU. Then, the smartphone adds information indicating the identified camera posture to the frame. The camera posture is relatively associated as an external parameter for each frame of the camera that has captured the moving image.

In the example of FIG. 4, the first moving image data and the second moving image data are transmitted from the smartphone, which is the imaging device 61, to the database 20. While the first moving image data and the second moving image data are separately captured in the example of FIG. 4, those pieces of data may be one piece of moving image data in a series. The first moving image data and the second moving image data may be created by the one piece of moving image data being divided.

In the example embodiment, the data acquisition unit 11 obtains, from the database 20, the three-dimensional data 21 of the object, the first moving image data 22, and the second moving image data 23. The data acquisition unit 11 outputs, to the camera posture calculation unit 12, the obtained three-dimensional data 21, first moving image data 22, and second moving image data 23.

The camera posture calculation unit 12 first compares the feature point of the frame including the first specific portion in the first moving image data with the feature points of the three-dimensional data to perform collation, thereby identifying a plurality of relevant points, which is relevant to each of the three-dimensional data and the frame image including the first specific portion. As a result, a region relevant to the specific portion is identified in the three-dimensional data.

Specifically, the camera posture calculation unit 12 first calculates feature values such as a Haar-Like feature value, a HOG feature value, and a SIFT feature value in the frame including the first specific portion. Next, the camera posture calculation unit 12 extracts a point at which the feature value is equal to or more than a predetermined value as a feature point.

The frame of the first specific portion may be designated by the user in advance. The camera posture calculation unit 12 may also identify the frame of the first specific portion by extracting feature points from all the frames of the first moving image data 22 and then searching for feature points having a designated feature value.

The camera posture calculation unit 12 executes matching between the feature point of the frame including the first specific portion and each point included in the three-dimensional point cloud data, which is the three-dimensional data 21. An existing method is used as a method of the matching processing between the feature points. Then, the camera posture calculation unit 12 identifies, based on a result of the matching, a plurality of feature points relevant to each of the three-dimensional data 21 and the frame image including the first specific portion. The feature points are identified in the three-dimensional data 21 and in the frame image, and are relevant to each other. Hereinafter, the feature points relevant to each other will be denoted as “relevant points”.

Subsequently, the camera posture calculation unit 12 calculates, using the plurality of identified relevant points, a three-dimensional camera posture (first three-dimensional camera posture) at a portion including the plurality of relevant points (portion relevant to the first specific portion) in the three-dimensional data 21. The first three-dimensional camera posture is a camera posture in the three-dimensional data 21 as a world coordinate system. Specifically, the camera posture calculation unit 12 calculates, as the first three-dimensional camera posture, an external parameter at the time of capturing the frame including the specific portion using the plurality of identified relevant points and an internal parameter of the camera at the time of capturing the frame including the first specific portion.

Subsequently, the camera posture calculation unit 12 identifies the camera posture retained in the frame including the first specific portion from the first moving image data 22, and identifies the camera posture retained in the frame including the second specific portion from the first moving image data 22 or from the second moving image data 23.

The frame of the second specific portion may also be designated by the user in advance. The camera posture calculation unit 12 may also identify the frame of the second specific portion by extracting feature points from all the frames of the first moving image data 22 or the second moving image data 23 and then searching for feature points having a designated feature value.

Subsequently, the camera posture calculation unit 12 calculates a difference between the camera posture retained in the frame including the first specific portion and the camera posture retained in the frame including the second specific portion. Then, the camera posture calculation unit 12 adds the calculated difference to the first three-dimensional camera posture. The camera posture obtained as a result corresponds to the camera posture at the portion relevant to the second specific portion in the three-dimensional data, that is, the second three-dimensional camera posture.

Subsequently, the camera posture calculation unit 12 identifies, from the second moving image data, the camera posture retained in the frame including the second specific portion and the camera posture retained in the frame including the inspection point.

The frame of the inspection point may also be designated by the user in advance. The camera posture calculation unit 12 may also identify the frame of the inspection point by extracting feature points from all the frames of the second moving image data 23 and then searching for feature points having a designated feature value.

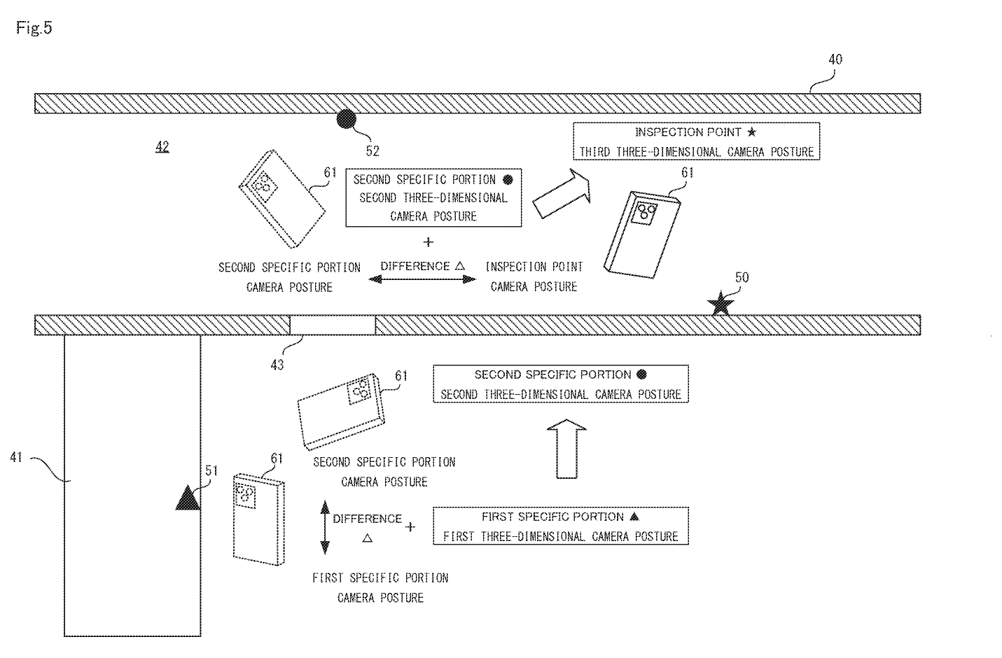

Subsequently, the camera posture calculation unit 12 calculates a difference between the camera posture retained in the frame including the second specific portion and the camera posture retained in the frame including the inspection point. Then, the camera posture calculation unit 12 adds the calculated difference to the second three-dimensional camera posture. The three-dimensional camera posture obtained as a result corresponds to the three-dimensional camera posture at the portion relevant to the inspection point in the three-dimensional data, that is, the third three-dimensional camera posture. FIG. 5 is a diagram for explaining an exemplary process in the camera posture calculation unit 12.

In the example embodiment, the position identification unit 13 calculates coordinates of the portion relevant to the inspection point in the three-dimensional data using the three-dimensional data 21 and the third three-dimensional camera posture (external parameter) at the portion relevant to the inspection point in the three-dimensional data. Specifically, the position identification unit 13 identifies a region included in a field of view of the camera using the third three-dimensional camera posture at the portion relevant to the inspection point in the three-dimensional data, and sets the position (coordinates) of the identified region as a position of the portion relevant to the inspection point in the three-dimensional data.

The display unit 14 displays the three-dimensional data of the object on, for example, a screen of the terminal device 30. The display unit further displays, on the screen, the region indicating the inspection point in a manner of being superimposed on the three-dimensional data using the coordinates of the portion relevant to the inspection point calculated by the position identification unit 13.

### Apparatus Operation

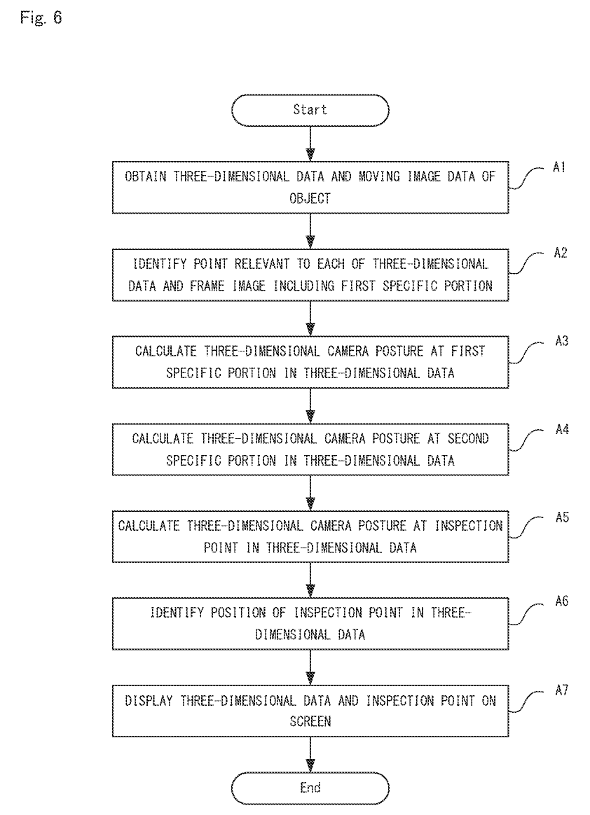

Next, an exemplary operation of the information processing apparatus 10 will be described with reference to FIG. 6. FIG. 6 is a flowchart illustrating an exemplary operation of the information processing apparatus 10. In the following descriptions, FIGS. 1 to 5 will be appropriately referred to. In the example embodiment, the information processing method is performed by the information processing apparatus 10 being operated. Thus, descriptions of the information processing method according to the example embodiment are substituted with the following descriptions of the operation of the information processing apparatus 10.

First, as a premise, the three-dimensional data 21 of the object is constructed, and the constructed three-dimensional data 21 is stored in the database 20. The database 20 further stores the first moving image data 22 obtained through the moving image capturing from the first specific portion to the second specific portion of the object, and the second moving image data 23 obtained through the moving image capturing from the second specific portion to the inspection point.

As illustrated in FIG. 6, first, the data acquisition unit 11 obtains, from the database 20, the three-dimensional data 21 of the object, the first moving image data 22, and the second moving image data 23 (step A1). The data acquisition unit 11 outputs, to the camera posture calculation unit 12, the obtained three-dimensional data 21, first moving image data 22, and second moving image data 23.

Next, the camera posture calculation unit 12 compares the feature point of the frame including the first specific portion in the first moving image data 22 with the feature points of the three-dimensional data to perform collation, thereby identifying a plurality of relevant points, which is relevant to each of the three-dimensional data and the frame image including the first specific portion (step A2).

Specifically, in step A2, the camera posture calculation unit 12 first extracts a feature point from the frame including the specific portion, and executes matching between the extracted feature point and each point included in the three-dimensional data 21. Then, the camera posture calculation unit 12 identifies, based on a result of the matching, a plurality of relevant points relevant to each of the three-dimensional data 21 and the frame image including the specific portion.

Next, the camera posture calculation unit 12 calculates, using the plurality of relevant points identified in step A2, a three-dimensional camera posture (first three-dimensional camera posture) at the portion including the plurality of relevant points (portion relevant to the first specific portion) in the three-dimensional data 21 (step A3).

Specifically, in step A3, the camera posture calculation unit 12 calculates, as the first three-dimensional camera posture, an external parameter of the camera at the time of capturing the frame including the specific portion using the plurality of relevant points identified in step A2 and the internal parameter of the camera at the time of capturing the frame including the specific portion.

Next, the camera posture calculation unit 12 calculates the second three-dimensional camera posture at the portion relevant to the second specific portion in the three-dimensional data using the camera posture retained in the frame including the second specific portion and the first three-dimensional camera posture calculated in step A3 (step A4).

Specifically, in step A4, the camera posture calculation unit 12 identifies, from the first moving image data 22, the camera posture retained in the frame including the first specific portion and the camera posture retained in the frame including the second specific portion, as illustrated in FIG. 5. Moreover, the camera posture calculation unit 12 calculates a difference between the two identified camera postures. Then, the camera posture calculation unit 12 adds the calculated difference to the first three-dimensional camera posture, and calculates a three-dimensional camera posture (second three-dimensional camera posture) at the portion relevant to the second specific portion in the three-dimensional data.

Next, the camera posture calculation unit 12 calculates a three-dimensional camera posture (third three-dimensional camera posture) at the portion relevant to the inspection point in the three-dimensional data using the camera posture retained in the frame including the inspection point in the second moving image data and the second three-dimensional camera posture calculated in step A4 (step A5).

Specifically, in step A5, the camera posture calculation unit 12 first identifies, from the second moving image data, the camera posture retained in the frame including the second specific portion and the camera posture retained in the frame including the inspection point. Then, the camera posture calculation unit 12 calculates a difference between the camera posture retained in the frame including the second specific portion and the camera posture retained in the frame including the inspection point. Thereafter, the camera posture calculation unit 12 adds the calculated difference to the second three-dimensional camera posture. The three-dimensional camera posture obtained as a result corresponds to the third three-dimensional camera posture.

Next, the position identification unit 13 identifies the position of the portion relevant to the inspection point in the three-dimensional data using the third three-dimensional camera posture at the portion relevant to the inspection point in the three-dimensional data calculated in step A5 (step A6).

Specifically, in step A6, the position identification unit 13 calculates the coordinates of the portion relevant to the inspection point in the three-dimensional data using the three-dimensional data 21 and the third three-dimensional camera posture calculated in step A5.

Next, the display unit 14 displays the three-dimensional data of the object on the screen of the terminal device 30, and further displays, using the coordinates of the point identified in step A6, the region indicating the inspection point in a manner of being superimposed on the three-dimensional data (step A7).

### Effects of Example Embodiment

As described above, according to the example embodiment, even in the case where the inspection point is inside the object, the inspection point does not appear in the three-dimensional data, and no data relevant to the inspection point is available, the three-dimensional camera posture (third three-dimensional camera posture) of the portion relevant to the inspection point in the three-dimensional data is calculated by using the first moving image data and the second moving image data. Thus, according to the information processing apparatus 10, alignment with the relevant portion of the three-dimensional point cloud data may be performed even in a case of an imaging portion that does not appear in the three-dimensional data of the object. According to the example embodiment, the region indicating the inspection point that does not appear in the three-dimensional data is displayed on the screen in a manner of being superimposed on the three-dimensional data, whereby a manager of the object may easily grasp the inspection point.

### Modified Example

Hereinafter, first to third modified examples of the example embodiment will be described.

### First Modified Example:

In the first modified example, three-dimensional interpolation is performed on the three-dimensional data 21, and the three-dimensional data 21 on which the three-dimensional interpolation is performed is stored in the database 20. The three-dimensional interpolation is performed to add a face of a portion in which data is missing.

Examples of a method of the three-dimensional interpolation include a method using a machine learning model. The machine learning model in this case is constructed by machine learning using a three-dimensional model in which a part is missing and three-dimensional data (training data) with no missing part. Examples of the method of the three-dimensional interpolation further include a method of interpolating data on the assumption that the missing part is a face continuous from the vicinity thereof.

According to the first modified example, the position identification unit 13 first identifies a region that may be included in the field of view of the camera of the three-dimensional data 21 using the three-dimensional camera posture at the portion relevant to the inspection point in the three-dimensional data 21. Then, the position identification unit 13 sets, in the identified region, a region included in the three-dimensional data as a position of the portion relevant to the inspection point.

In the case of the first modified example, the position of the portion relevant to the inspection point in the three-dimensional data may be identified more accurately.

### Second Modified Example:

In the second modified example, the moving image data also retain, for each frame, depth information for identifying a depth from the imaging device 61 to the object in addition to the camera posture. In the second modified example, the imaging device 61 includes, in addition to the normal camera, a depth sensor such as LiDAR, and measures a depth to a subject each time of capturing. In the second modified example, it is sufficient if the information regarding the depth to the subject is added only to the frame including the inspection point.

Thus, according to the second modified example, the position identification unit 13 identifies the position of the portion relevant to the inspection point in the three-dimensional data using the three-dimensional camera posture at the portion relevant to the inspection point in the three-dimensional data and the depth information retained in the frame including the inspection point.

Also in the case of the second modified example, the position of the portion relevant to the inspection point in the three-dimensional data may be identified more accurately.

### Third Modified Example:

In the third modified example, the depth information used in the second modified example is calculated from a plurality of frame images including the inspection point. At this time, a relative imaging position of each frame image is known from the sensor data from the IMU. Thus, since the depth information in the frame including the inspection point is obtained according to the principle of triangulation, the coordinates of the portion relevant to the inspection point in the three-dimensional data may be calculated.

Also in the case of the third modified example, the position of the portion relevant to the inspection point in the three-dimensional data may be identified more accurately.

### Program

The program according to the example embodiment only needs to be a program that causes a computer to execute steps A1 to A7 illustrated in FIG. 6. The information processing apparatus 10 and the information processing method may be achieved by the program being installed and executed in the computer. In that case, a processor of the computer functions as the data acquisition unit 11, the camera posture calculation unit 12, the position identification unit 13, and the display unit 14, and performs processing. Examples of the computer include a smartphone and a tablet terminal device in addition to a general-purpose personal computer (PC) and a server computer.

The program according to the example embodiment may be executed by a computer system constructed by a plurality of computers. In that case, for example, each of the computers may function as any of the data acquisition unit 11, the camera posture calculation unit 12, the position identification unit 13, and the display unit 14.

### Physical Configuration

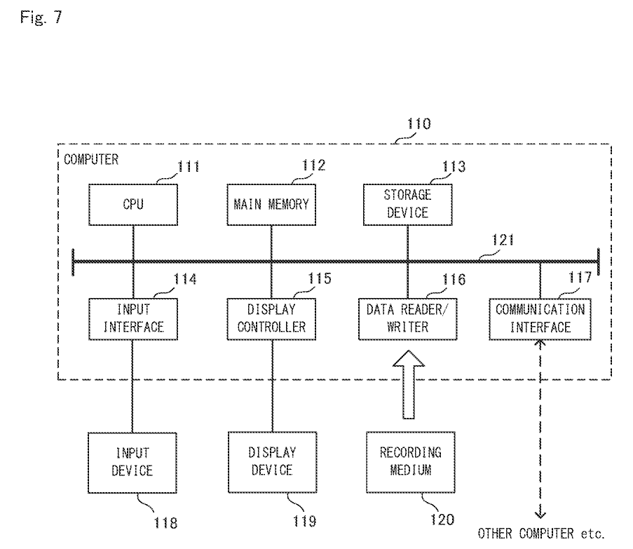

Here, the computer that achieves the information processing apparatus 10 by executing the program according to the example embodiment will be described with reference to FIG. 7. FIG. 7 is a block diagram illustrating an example of the computer that achieves the information processing apparatus.

As illustrated in FIG. 7, a computer 110 includes a central processing unit (CPU) 111, a main memory 112, a storage device 113, an input interface 114, a display controller 115, a data reader/writer 116, and a communication interface 117. Those units are data-communicably connected to each other via a bus 121.

The computer 110 may include a graphics processing unit (GPU) or a field-programmable gate array (FPGA) in addition to the CPU 111 or instead of the CPU 111. In this mode, the GPU or the FPGA may execute the program according to the example embodiment.

The CPU 111 loads the program according to the example embodiment, which is stored in the storage device 113 and includes codes, into the main memory 112, and executes each code in a predetermined order, thereby performing various operations. The main memory 112 is typically a volatile storage device such as a dynamic random access memory (DRAM).

The program according to the example embodiment is provided in a state of being stored in a computer-readable recording medium 120. The program according to the present example embodiment may be distributed on the Internet connected via the communication interface 117.

Specific examples of the storage device 113 include a semiconductor storage device such as a flash memory in addition to a hard disk drive. The input interface 114 mediates data transmission between the CPU 111 and an input device 118 such as a keyboard and a mouse. The display controller 115 is connected to a display device 119, and controls display on the display device 119.

The data reader/writer 116 mediates data transmission between the CPU 111 and the recording medium 120, and reads the program from the recording medium 120 and writes a result of processing by the computer 110 into the recording medium 120. The communication interface 117 mediates data transmission between the CPU 111 and another computer.

Specific examples of the recording medium 120 include a general-purpose semiconductor storage device such as Compact Flash (CF) (registered trademark) and Secure Digital (SD), a magnetic recording medium such as a flexible disk, and an optical recording medium such as a compact disk read only memory (CD-ROM).

The information processing apparatus 10 may also be achieved by using hardware relevant to each unit, such as an electronic circuit, instead of the computer in which the program is installed. Moreover, a part of the information processing apparatus 10 may be achieved by the program, and the remaining part may be achieved by hardware. In the example embodiment, the computer is not limited to the computer illustrated in FIG. 6.

Some or all of the example embodiments described above may be expressed as, but are not limited to, the following (Supplementary Note 1) to (Supplementary Note 18).

### Supplementary Note 1

An information processing apparatus including:

a data acquisition unit that obtains first moving image data, which is generated by capturing a moving image of an object from a first specific portion to a second specific portion and retains a camera posture at a time of capturing the moving image for each frame, and second moving image data, which is generated by capturing the object from the second specific portion to an inspection point and retains the camera posture at the time of capturing the moving image for each frame;

a camera posture calculation unit configured to:

compare a frame including the first specific portion in the first moving image data with three-dimensional data of the object, and calculate, as a first three-dimensional camera posture, the camera posture at a portion relevant to the first specific portion in the three-dimensional data;

calculate, as a second three-dimensional camera posture, the camera posture at a portion relevant to the second specific portion in the three-dimensional data using the first three-dimensional camera posture and the camera posture retained in a frame including the second specific portion; and

calculate, as a third three-dimensional camera posture, the camera posture at a portion relevant to the inspection point in the three-dimensional data using the second three-dimensional camera posture and the camera posture retained in a frame including the inspection point in the second moving image data; and

a position identification unit that identifies a position of the portion relevant to the inspection point in the three-dimensional data using the third three-dimensional camera posture.

### Supplementary Note 2

The information processing apparatus according to Supplementary Note 1, in which

the camera posture calculation unit is configured to:

calculate a difference between the camera posture retained in the frame including the first specific portion in the first moving image data and the camera posture retained in the frame including the second specific portion in the first moving image data, and calculate the second three-dimensional camera posture by adding the calculated difference to the first three-dimensional camera posture; and

calculate a difference between the camera posture retained in the frame including the second specific portion in the second moving image data and the camera posture retained in the frame including the inspection point in the second moving image data, and calculate the third three-dimensional camera posture by adding the calculated difference to the second three-dimensional camera posture.

### Supplementary Note 3

The information processing apparatus according to Supplementary Note 1, in which

the camera posture calculation unit is configured to:

perform collation by comparing a feature point of the frame including the first specific portion in the first moving image data with a feature point of the three-dimensional data to identify a plurality of the feature points relevant to each of the three-dimensional data and a frame image including the first specific portion, and calculate, as the first three-dimensional camera posture, the camera posture at a portion including the plurality of identified feature points.

### Supplementary Note 4

The information processing apparatus according to Supplementary Note 1, in which the position identification unit identifies a region included in a field of view of a camera of the three-dimensional data using the third three-dimensional camera posture, and sets a position of the identified region as the position of the portion relevant to the inspection point in the three-dimensional data.

### Supplementary Note 5

The information processing apparatus according to Supplementary Note 1, in which

the second moving image data further retains depth information for specifying a depth from a camera to the object at least in the frame including the inspection point, and

the position identification unit identifies the position of the portion relevant to the inspection point in the three-dimensional data using the third three-dimensional camera posture and the depth information retained in the frame including the inspection point.

### Supplementary Note 6

The information processing apparatus according to Supplementary Note 1, further including:

a display unit that displays the three-dimensional data on a screen, in which

the display unit also displays, on the screen, the portion relevant to the inspection point in a manner of being superimposed on the three-dimensional data.

### Supplementary Note 7

An information processing method including:

a data acquisition step of obtaining first moving image data, which is generated by capturing a moving image of an object from a first specific portion to a second specific portion and retains a camera posture at a time of capturing the moving image for each frame, and second moving image data, which is generated by capturing the object from the second specific portion to an inspection point and retains the camera posture at the time of capturing the moving image for each frame;

a camera posture calculation step including:

comparing a frame including the first specific portion in the first moving image data with three-dimensional data of the object, and calculating, as a first three-dimensional camera posture, the camera posture at a portion relevant to the first specific portion in the three-dimensional data;

calculating, as a second three-dimensional camera posture, the camera posture at a portion relevant to the second specific portion in the three-dimensional data using the first three-dimensional camera posture and the camera posture retained in a frame including the second specific portion; and

calculating, as a third three-dimensional camera posture, the camera posture at a portion relevant to the inspection point in the three-dimensional data using the second three-dimensional camera posture and the camera posture retained in a frame including the inspection point in the second moving image data; and

a position identification step of identifying a position of the portion relevant to the inspection point in the three-dimensional data using the third three-dimensional camera posture.

### Supplementary Note 8

The information processing method according to Supplementary Note 7, further including:

in the camera posture calculation step,

calculating a difference between the camera posture retained in the frame including the first specific portion in the first moving image data and the camera posture retained in the frame including the second specific portion in the first moving image data, and calculating the second three-dimensional camera posture by adding the calculated difference to the first three-dimensional camera posture; and

calculating a difference between the camera posture retained in the frame including the second specific portion in the second moving image data and the camera posture retained in the frame including the inspection point in the second moving image data, and calculating the third three-dimensional camera posture by adding the calculated difference to the second three-dimensional camera posture.

### Supplementary Note 9

The information processing method according to Supplementary Note 7, further including:

in the camera posture calculation step,

performing collation by comparing a feature point of the frame including the first specific portion in the first moving image data with a feature point of the three-dimensional data to identify a plurality of the feature points relevant to each of the three-dimensional data and a frame image including the first specific portion, and calculating, as the first three-dimensional camera posture, the camera posture at a portion including the plurality of identified feature points.

### Supplementary Note 10

The information processing method according to Supplementary Note 7, further including, in the position identification step, identifying a region included in a field of view of a camera of the three-dimensional data using the third three-dimensional camera posture, and setting a position of the identified region as the position of the portion relevant to the inspection point in the three-dimensional data.

### Supplementary Note 11

The information processing method according to Supplementary Note 7, in which

the second moving image data further retains depth information for specifying a depth from a camera to the object at least in the frame including the inspection point, the method further including:

in the position identification step, identifying the position of the portion relevant to the inspection point in the three-dimensional data using the third three-dimensional camera posture and the depth information retained in the frame including the inspection point.

### Supplementary Note 12

The information processing method according to Supplementary Note 7, further including:

a display step of displaying the three-dimensional data on a screen, in which

in the display step, the portion relevant to the inspection point is displayed on the screen in a manner of being superimposed on the three-dimensional data.

### Supplementary Note 13

A computer-readable recording medium recording a program including an instruction for causing a computer to perform a process including:

a data acquisition step of obtaining first moving image data, which is generated by capturing a moving image of an object from a first specific portion to a second specific portion and retains a camera posture at a time of capturing the moving image for each frame, and second moving image data, which is generated by capturing the object from the second specific portion to an inspection point and retains the camera posture at the time of capturing the moving image for each frame;

a camera posture calculation step including:

comparing a frame including the first specific portion in the first moving image data with three-dimensional data of the object, and calculating, as a first three-dimensional camera posture, the camera posture at a portion relevant to the first specific portion in the three-dimensional data;

calculating, as a second three-dimensional camera posture, the camera posture at a portion relevant to the second specific portion in the three-dimensional data using the first three-dimensional camera posture and the camera posture retained in a frame including the second specific portion; and

calculating, as a third three-dimensional camera posture, the camera posture at a portion relevant to the inspection point in the three-dimensional data using the second three-dimensional camera posture and the camera posture retained in a frame including the inspection point in the second moving image data; and

a position identification step of identifying a position of the portion relevant to the inspection point in the three-dimensional data using the third three-dimensional camera posture.

### Supplementary Note 14

The computer-readable recording medium according to Supplementary Note 13, in which

in the camera posture calculation step,

a difference between the camera posture retained in the frame including the first specific portion in the first moving image data and the camera posture retained in the frame including the second specific portion in the first moving image data is calculated, and the calculated difference is added to the first three-dimensional camera posture to calculate the second three-dimensional camera posture, and

a difference between the camera posture retained in the frame including the second specific portion in the second moving image data and the camera posture retained in the frame including the inspection point in the second moving image data is calculated, and the calculated difference is added to the second three-dimensional camera posture to calculate the third three-dimensional camera posture.

### Supplementary Note 15

The computer-readable recording medium according to Supplementary Note 13, in which

in the camera posture calculation step,

collation is performed by comparing a feature point of the frame including the first specific portion in the first moving image data with a feature point of the three-dimensional data to identify a plurality of the feature points relevant to each of the three-dimensional data and a frame image including the first specific portion, and the camera posture at a portion including the plurality of identified feature points is calculated as the first three-dimensional camera posture.

### Supplementary Note 16

The computer-readable recording medium according to Supplementary Note 13, in which, in the position identification step, a region included in a field of view of a camera of the three-dimensional data is identified using the third three-dimensional camera posture, and a position of the identified region is set as the position of the portion relevant to the inspection point in the three-dimensional data.

### Supplementary Note 17

The computer-readable recording medium according to Supplementary Note 13, in which

the second moving image data further retains depth information for specifying a depth from a camera to the object at least in the frame including the inspection point, and

in the position identification step, the position of the portion relevant to the inspection point in the three-dimensional data is identified using the third three-dimensional camera posture and the depth information retained in the frame including the inspection point.

### Supplementary Note 18

The computer-readable recording medium according to Supplementary Note 13, the medium recording the program including the instruction for causing the computer to perform the process further including:

a display step of displaying the three-dimensional data on a screen, in which

in the display step, the portion relevant to the inspection point is displayed on the screen in a manner of being superimposed on the three-dimensional data.

While the present invention has been particularly shown and described with reference to example embodiments thereof, the present invention is not limited to these example embodiments. It will be understood by those of ordinary skill in the art that various changes in form and details may be made therein without departing from the spirit and scope of the present invention as defined by the claims.

As described above, according to the present disclosure, alignment with a relevant portion of three-dimensional point cloud data may be performed even in a case of an imaging portion that does not appear in three-dimensional data of an object. The present disclosure is useful in fields where matching of three-dimensional data and images is required, for example, management of infrastructures.

1. An information processing apparatus comprising:
at least one memory storing instructions; and
at least one processor configured to execute the instructions to:
obtain first moving image data, which is generated by capturing a moving image of an object from a first specific portion to a second specific portion and retains a camera posture at a time of capturing the moving image for each frame, and second moving image data, which is generated by capturing the object from the second specific portion to an inspection point and retains the camera posture at the time of capturing the moving image for each frame;
compare a frame including the first specific portion in the first moving image data with three-dimensional data of the object, and calculate, as a first three-dimensional camera posture, the camera posture at a portion relevant to the first specific portion in the three-dimensional data;
calculate, as a second three-dimensional camera posture, the camera posture at a portion relevant to the second specific portion in the three-dimensional data using the first three-dimensional camera posture and the camera posture retained in a frame including the second specific portion; and
calculate, as a third three-dimensional camera posture, the camera posture at a portion relevant to the inspection point in the three-dimensional data using the second three-dimensional camera posture and the camera posture retained in a frame including the inspection point in the second moving image data; and
identify a position of the portion relevant to the inspection point in the three-dimensional data using the third three-dimensional camera posture.

2. The information processing apparatus according to claim 1, wherein
at least one processor:
calculates a difference between the camera posture retained in the frame including the first specific portion in the first moving image data and the camera posture retained in the frame including the second specific portion in the first moving image data, and calculates the second three-dimensional camera posture by adding the calculated difference to the first three-dimensional camera posture; and
calculates a difference between the camera posture retained in the frame including the second specific portion in the second moving image data and the camera posture retained in the frame including the inspection point in the second moving image data, and calculates the third three-dimensional camera posture by adding the calculated difference to the second three-dimensional camera posture.

3. The information processing apparatus according to claim 1, wherein
at least one processor:
performs collation by comparing a feature point of the frame including the first specific portion in the first moving image data with a feature point of the three-dimensional data to identify a plurality of the feature points relevant to each of the three-dimensional data and a frame image including the first specific portion, and calculates, as the first three-dimensional camera posture, the camera posture at a portion including the plurality of identified feature points.

4. The information processing apparatus according to claim 1, wherein
at least one processor identifies a region included in a field of view of a camera of the three-dimensional data using the third three-dimensional camera posture, and sets a position of the identified region as the position of the portion relevant to the inspection point in the three-dimensional data.

5. The information processing apparatus according to claim 1, wherein
the second moving image data further retains depth information for specifying a depth from a camera to the object at least in the frame including the inspection point, and
at least one processor identifies the position of the portion relevant to the inspection point in the three-dimensional data using the third three-dimensional camera posture and the depth information retained in the frame including the inspection point.

6. The information processing apparatus according to claim 1, wherein
at least one processor displays the three-dimensional data on a screen, and also displays, on the screen, the portion relevant to the inspection point in a manner of being superimposed on the three-dimensional data.

7. An information processing method comprising:
obtaining first moving image data, which is generated by capturing a moving image of an object from a first specific portion to a second specific portion and retains a camera posture at a time of capturing the moving image for each frame, and second moving image data, which is generated by capturing the object from the second specific portion to an inspection point and retains the camera posture at the time of capturing the moving image for each frame;
comparing a frame including the first specific portion in the first moving image data with three-dimensional data of the object, and calculating, as a first three-dimensional camera posture, the camera posture at a portion relevant to the first specific portion in the three-dimensional data;
calculating, as a second three-dimensional camera posture, the camera posture at a portion relevant to the second specific portion in the three-dimensional data using the first three-dimensional camera posture and the camera posture retained in a frame including the second specific portion;
calculating, as a third three-dimensional camera posture, the camera posture at a portion relevant to the inspection point in the three-dimensional data using the second three-dimensional camera posture and the camera posture retained in a frame including the inspection point in the second moving image data; and
identifying a position of the portion relevant to the inspection point in the three-dimensional data using the third three-dimensional camera posture.

8. The information processing method according to claim 7, further comprising:
in the calculating the camera posture,
calculating a difference between the camera posture retained in the frame including the first specific portion in the first moving image data and the camera posture retained in the frame including the second specific portion in the first moving image data, and calculating the second three-dimensional camera posture by adding the calculated difference to the first three-dimensional camera posture; and
calculating a difference between the camera posture retained in the frame including the second specific portion in the second moving image data and the camera posture retained in the frame including the inspection point in the second moving image data, and calculating the third three-dimensional camera posture by adding the calculated difference to the second three-dimensional camera posture.

9. The information processing method according to claim 7, further comprising:
in the calculating the camera posture,
performing collation by comparing a feature point of the frame including the first specific portion in the first moving image data with a feature point of the three-dimensional data to identify a plurality of the feature points relevant to each of the three-dimensional data and a frame image including the first specific portion, and calculating, as the first three-dimensional camera posture, the camera posture at a portion including the plurality of identified feature points.

10. The information processing method according to claim 7, further comprising, in the identifying the position, identifying a region included in a field of view of a camera of the three-dimensional data using the third three-dimensional camera posture, and setting a position of the identified region as the position of the portion relevant to the inspection point in the three-dimensional data.

11. The information processing method according to claim 7, wherein
the second moving image data further retains depth information for specifying a depth from a camera to the object at least in the frame including the inspection point, the method further comprising:
in the identifying the position, identifying the position of the portion relevant to the inspection point in the three-dimensional data using the third three-dimensional camera posture and the depth information retained in the frame including the inspection point.

12. The information processing method according to claim 7, further comprising:
displaying the three-dimensional data on a screen; and
displaying, on the screen, the portion relevant to the inspection point in a manner of being superimposed on the three-dimensional data.

13. A non-transitory computer-readable recording medium recording a program including an instruction for causing a computer to perform a process comprising:
obtaining first moving image data, which is generated by capturing a moving image of an object from a first specific portion to a second specific portion and retains a camera posture at a time of capturing the moving image for each frame, and second moving image data, which is generated by capturing the object from the second specific portion to an inspection point and retains the camera posture at the time of capturing the moving image for each frame;
comparing a frame including the first specific portion in the first moving image data with three-dimensional data of the object, and calculating, as a first three-dimensional camera posture, the camera posture at a portion relevant to the first specific portion in the three-dimensional data;
calculating, as a second three-dimensional camera posture, the camera posture at a portion relevant to the second specific portion in the three-dimensional data using the first three-dimensional camera posture and the camera posture retained in a frame including the second specific portion;
calculating, as a third three-dimensional camera posture, the camera posture at a portion relevant to the inspection point in the three-dimensional data using the second three-dimensional camera posture and the camera posture retained in a frame including the inspection point in the second moving image data; and
identifying a position of the portion relevant to the inspection point in the three-dimensional data using the third three-dimensional camera posture.

14. The non-transitory computer-readable recording medium according to claim 13, further comprising:
in the calculating the camera posture,
calculating a difference between the camera posture retained in the frame including the first specific portion in the first moving image data and the camera posture retained in the frame including the second specific portion in the first moving image data, and calculating the second three-dimensional camera posture by adding the calculated difference to the first three-dimensional camera posture; and
calculating a difference between the camera posture retained in the frame including the second specific portion in the second moving image data and the camera posture retained in the frame including the inspection point in the second moving image data, and calculating the third three-dimensional camera posture by adding the calculated difference to the second three-dimensional camera posture.

15. The non-transitory computer-readable recording medium according to claim 13, the medium recording the program for causing the computer to perform the process further comprising:
in the calculating the camera posture,
performing collation by comparing a feature point of the frame including the first specific portion in the first moving image data with a feature point of the three-dimensional data to identify a plurality of the feature points relevant to each of the three-dimensional data and a frame image including the first specific portion, and calculating, as the first three-dimensional camera posture, the camera posture at a portion including the plurality of identified feature points.

16. The non-transitory computer-readable recording medium according to claim 13, the medium recording the program for causing the computer to perform the process further comprising:
in the identifying the position, identifying a region included in a field of view of a camera of the three-dimensional data using the third three-dimensional camera posture, and setting a position of the identified region as the position of the portion relevant to the inspection point in the three-dimensional data.

17. The non-transitory computer-readable recording medium according to claim 13, wherein
the second moving image data further retains depth information for specifying a depth from a camera to the object at least in the frame including the inspection point,
the medium recording the program for causing the computer to perform the process further comprising:
in the identifying the position, identifying the position of the portion relevant to the inspection point in the three-dimensional data using the third three-dimensional camera posture and the depth information retained in the frame including the inspection point.

18. The non-transitory computer-readable recording medium according to claim 13, the medium recording the program for causing the computer to perform the process further comprising:
displaying the three-dimensional data on a screen; and
displaying, on the screen, the portion relevant to the inspection point in a manner of being superimposed on the three-dimensional data.
